(19) United States
(12) Patent Application Publication
(10) Pub. No.: US 2005/0250360 A1
(43) Pub. Date: Nov. 10, 2005

(54) Multiuse power entry module

(75) Inventor: Michael A. Cantie, North Chili, NY (US)

Correspondence Address: Mark G. Bocchetti;Eastman Kodak Company, Patent Legal Staff, 343 State Street, Rochester, NY, 14650-2201, US

(73) Assignee: Eastman Kodak Company

(21) Appl. No.: 10/842,126

(22) Filed: May 10, 2004

(51) Int. Cl. H01R 4/66

(52) U.S. Cl. 439/100

(57) ABSTRACT

The multiuse locking power entry module with cordage for supplying power from an outside source to equipment with which the module is in association includes a power connecting interface, a safety ground wire, and cordage. The cordage is an insulated wire for transferring power from an outside source to the power connecting interface. The power connecting interface, the safety ground wire, and a portion of the cordage, are encapsulated in a thermoplastic material. A first locking retainer is formed from the thermoplastic material on a first side of the encapsulated interface, wire and cordage. A second locking retainer is formed from the thermoplastic material on a second side of the outside of the encapsulated interface, wire and cordage.

### FIELD OF THE INVENTION

The present embodiments relate to multiuse locking power entry modules with cordage for supplying power from an outside source to equipment with which the module is in association

### BACKGROUND OF THE INVENTION

Power entry modules are known, as for examples shown by Schneider U.S. Pat. No. 4,622,526. The Schneider reference discloses a similar power line filter using a pair of inductors, wherein a printed circuit board has an extended grounding area to which are connected parallel capacitors, a pair of line inductors and a parallel resistor. Each inductor is formed as a multi-section coil wound on a plastic bobbin and two wound inductors are connected on rectangular cores to form line inductors. At least two of the capacitors are rectangular in shape and are mounted on opposite ends of the line inductors. Electrically, the circuit places an input capacitor and resistor across the input of the power lines, inductors in series with each line in an output capacitive network.

Current kiosk assemblies include the module, a wire harness, four locking nuts, a cover, a ground wire and a strain relief bushing. The assembly process can be an arduous task since the operator has to reach into the cabinet from the back and perform the assembly in a small confined area.

The device herein eliminates 90% of the assembly work and decreases the number of parts used to a quantity of two components. The device would be fed though the existing hole in a kiosk and the assembly would snap in place in one embodiment, with just securing the primary safety ground to the cabinet chassis.

Such modules are used to connect and fuse an incoming power line to equipment.

### SUMMARY OF THE INVENTION

The multiuse locking power entry module with cordage for supplying power from an outside source to equipment has a power connecting interface, a safety ground wire, and cordage. The cordage is an insulated wire for transferring power from an outside source to the power connecting interface. The power connecting interface, the safety ground wire, and a portion of the cordage are encapsulated in a thermoplastic material. A first locking retainer is formed from the thermoplastic material on a first side of the encapsulated interface, wire and cordage. A second locking retainer is formed from the thermoplastic material on a second side of the outside of the encapsulated interface, wire and cordage.

The device minimizes part count, reduces cost, and minimizes assembly time. The device maximizes safety because the device is insulated by molding and has no accessible locations to the primary AC power aside from the actual connectors.

### BRIEF DESCRIPTION OF THE DRAWINGS

In the detailed description of the preferred embodiments presented below, reference is made to the accompanying drawings, in which:

FIG. 1 depicts a side view of the device with a spring loaded retaining assembly.

FIG. 2 depicts a side view of a second embodiment of the device.

FIG. 3 depicts a top view of FIG. 2.

FIG. 4 depicts a front view of the embodiment of FIG. 2.

FIG. 5 depicts a side view of FIG. 1 wherein the module is mounted to a panel.

FIG. 6 depicts a side view of a third embodiment of the device.

FIG. 7 depicts a general schematic of a digital imaging device configured as a kiosk.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways.

The device reduces the cost to make power entry modules for installation, particularly in kiosks, and minimizes the number of pieces needed to assemble electrical equipment that have to connect to a power source. The device was designed for repeated use with an ability to lock onto a securely established a secure power connection, which can sustain vibration, without interrupting the supply of power. The module is particular usable for kiosks that have to sit on surfaces that vibrate, such as vessels at sea, trains, and airplanes.

The device has a molded feature for holding the power interface and the cordage securely. The device can have an alternative feature of locking retainers that can be spring loaded or flanged. The locking retainers can be molded from thermoplastic material enabling a lower cost construction and a more secure and stable device.

The device minimizes the assembly process time for AC or DC power entry into a kiosk or other piece of equipment. The device provides flexibility in design that allows for a uniform appearance in arrangement of kiosk equipment layout. This device can be molded or vacuum formed from liquid thermoplastic. The device can hold the traditional power interfaces and cordage. The device can be adapted to include switches, fuses, circuit breakers, filters or combinations of these items.

This device provides a higher level of safety because the terminal connections are molded into the part. The strain relief is much better and the insulation is enhanced by using an appropriate thermoplastic material, such as a flame resistant thermoplastic.

With reference to the figure, FIG. 1 illustrates the multiuse locking power entry module 8 with cordage. The module has several versions and provides a secure fit, locking and removable assembly that provides power from an outside source to equipment.

FIG. 1 shows the power connecting interface 12, a safety ground wire 14, and cordage 16. The interface 12, wire 14, and cordage 16 are encapsulated in a flame resistant thermoplastic material 18 that forms an encapsulated body.

The power connecting interface 12 can be a standard power connector interface shape with an EN60320 shape (IEC 320), NEMA 5-15 shape, NEMA 5-20 shape, IEC 19 shape, IEC 14 shape or similar shapes established by the National Electrical Manufacturers Association (NEMA). The power connecting interface can be separate from or in part from the thermoplastic material 18 to shape the interface into a proper shape to comply with the NEMA standards.

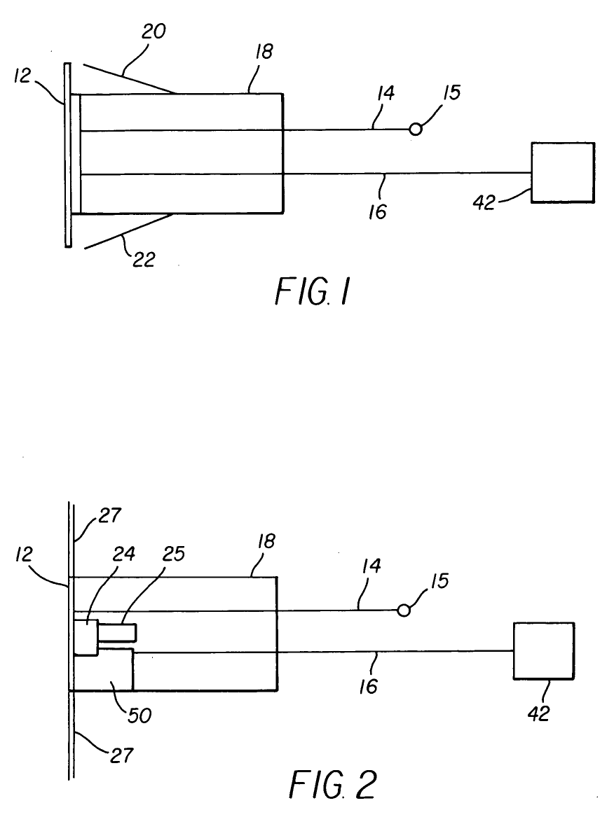

The safety ground wire 14 is preferably a molded, green and yellow, striped wire specified by regulatory agencies, such as Underwriters Laboratory (UL) or Canadians Standards Association (CSA). Optionally, the safety ground wire 14 has a terminal connector, such as a ring connector 15, as depicted in FIG. 2.

The cordage 16 used in with the device is either a single conductor cable or a multiple conductor cable. The cordage can be oriented such that the cordage is perpendicular to any face, except the power connecting interface 12 of the module. The orientation means the cordage can be at a right angle to the power connecting interface 12 or parallel to the power connecting interfaces 12. An example of cordage usable with the device is part number 1440118302 supplied by Mega Electronics of New Brunswick, N.J.

The thermoplastic material 18 is usable with the device includes polyamides that meet a flame rating of UL 94V-0, a well established rating from Underwriters Laboratories. Other plastics that can be molded and used as encapsulating agents can also be used in the alternative for the thermoplastic material 18.

FIG. 1 shows the two locking retainers 20 and 22. In the embodiment of FIG. 1, the first locking retainer 20 and the second locking retainer 22 are formed from the thermoplastic material 18. The locking retainers 20 and 22 are spring retainer fingers that extend from the body of the thermoplastic material 18 for engaging a mounting panel. FIG. 1 shows that a switch 48 can be optionally embedded within the thermoplastic material 18 and connected between the power connecting interface and the cordage.

FIG. 2 shows an alternative embodiment of the device wherein the two locking retainers 20 and 22 are flanges with holes or openings for receiving a retention device. FIG. 2 shows on of the flanges 24. FIG. 4 shows both flanges 24 and 26. The flanges are made from the thermoplastic material and molded as part of the process. The flanges 24 and 26 each have a hole 28 and 30, as shown in FIG. 4.

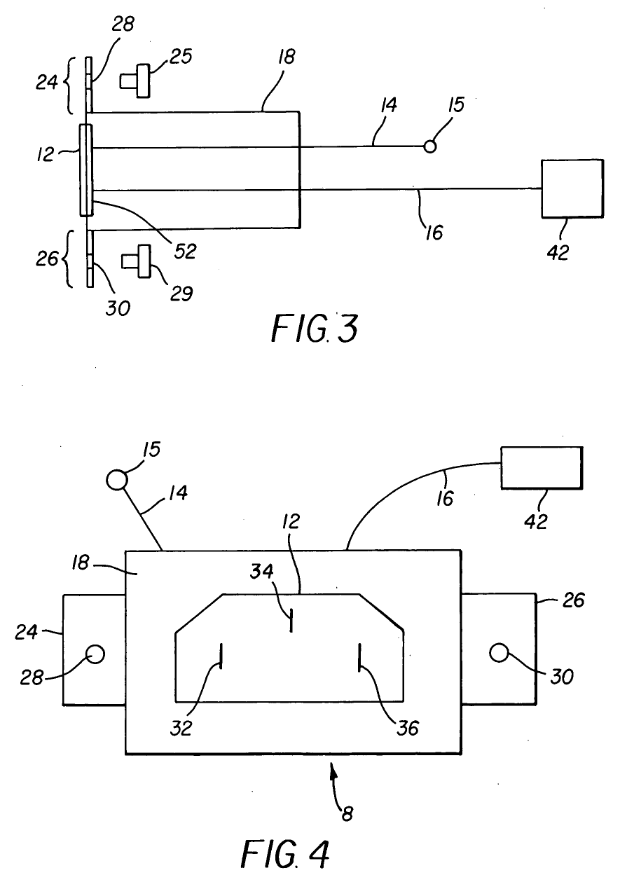

In FIG. 2, the flange hole is shown filled by a first bolt 25. A second bolt 29, shown in FIG. 3, fills the second flange hold for a secure fit. As an alternative to bolts, one or more threaded screws, one or more bolts, plastic retaining devices, or combinations thereof could be used. FIG. 6 depicts the embodiment wherein the flanges include at least one formed retaining device 44 and 46 shown as threaded studs.

FIG. 3 is a top view of the device with the two molded thermoplastic flanges 24 and 26 and, additionally, a circuit breaker (52) embedded within the thermoplastic material 18. The circuit breaker is connected between the power connecting interface and the cordage.

FIG. 3 additionally depicts cordage 16 connecting to a secondary power interface 42. The two bolts 25 and 29 are shown in the figure engaging the flanges to a mounting panel or mounting surface.

FIG. 4 is a front view of the embodiment of FIG. 3. FIG. 4 depicts the power entry module 8, a multi-use module. The power entry module 8 has a power connecting interface 12, a safety ground wire 14 with a ring terminal 15, cordage 16, thermoplastic material 18 embedding the cordage 16, and a safety ground wire and forming the first flange 24 and the second flange 26. Both the first flange 24 and the second flange 26 have a hole or opening 30. More than one opening can be used in each flange depending on the need of the user. FIG. 4 depicts the embodiment, wherein the power connecting interface 12 has a first power node 32, a second power node 34, and a third power node 36. The cordage 16 connects to a secondary power interface 42 to obtain power from a source (not shown).

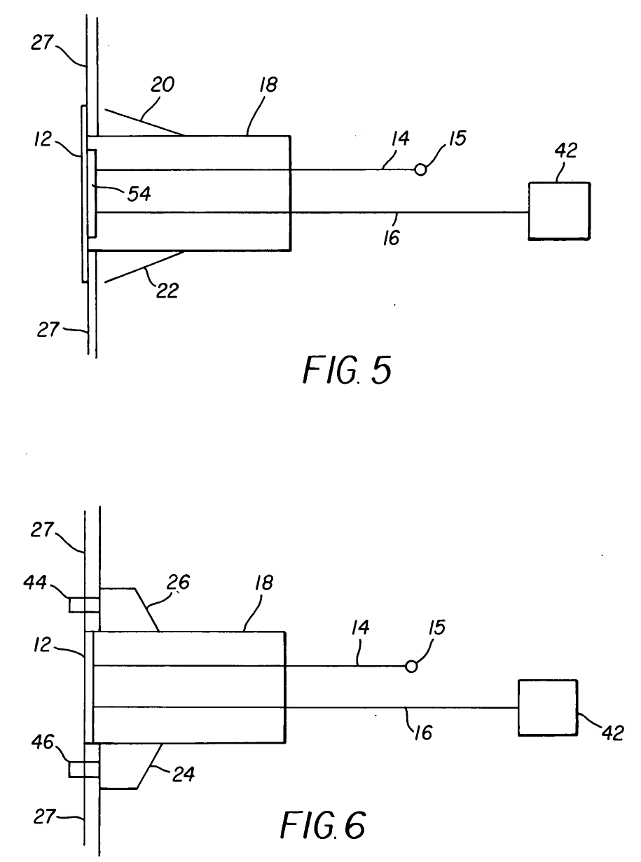

FIG. 5 shows a version of the embodiment of FIG. 1 connected to a panel 27. The panel 27 could be a wall, a shell, housing, or other mounting surface. In FIG. 5, the power connecting interface 12 is shown with the safety ground wire 14 and ring terminal 15 for the safety ground wire. The cordage 16 is depicted entirely contained within the thermoplastic material 18. The thermoplastic material 18 additionally forms the first locking retainer 20 and second locking retainer 22. The first and second locking retainers 20 and 22 are shown in FIG. 5 as a spring finger assemblies projecting from the body of the thermoplastic material. A secondary power interface is shown 42 connected to the cordage 16. FIG. 5 depicts the filter 54 embedded within the thermoplastic material 18 and connected between the power connecting interface and the cordage.

FIG. 6 shows the first and second locking retainers 20 and 22 as a first formed retaining device 44 and a second formed retaining device 46 that are mounted to the panel to receive the module 27. As mentioned earlier, the first and second formed retaining devices are made from the same thermoplastic material 18 as the body and the flanges and act as studs to engage the panel 27. In an embodiment, the studs can be retained by a nut or similar device.

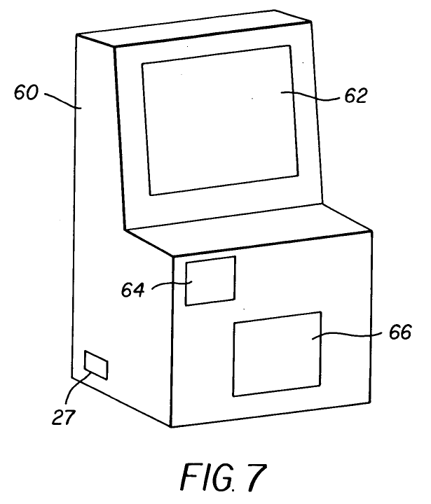

FIG. 7 depicts that the multiuse locking power entry module can be used with devices, such as a kiosk 60. An example of a kiosk 60 is a Picture Maker™ kiosk produced by Eastman Kodak Company. The kiosk 60 typically includes a touch display 62 for displaying a digital image and an input port 64 adapted to receive a digital storage device. Examples of digital storage devices are memory cards, memory sticks, media cards, compact flash cards, floppy disks, compact discs, PictureCDs, or the like, as known to those skilled in the art. Kiosk 60 can optionally include an optional delivery section 66 controlling the delivery of a medium.

Continuing with FIG. 7, the kiosk 60 can include the panel 27 to receive the module. A detailed view of the panel 27 is shown in FIG. 6. The module minimizes the assembly process time for AC or DC power entry into a kiosk or other piece of equipment. The module provides flexibility in design that allows for a uniform appearance in arrangement of kiosk equipment layout and can hold the traditional power interfaces and cordage. The module can be adapted to include switches, fuses, circuit breakers, filters or combinations of these items needed for the kiosk.

The embodiments have been described in detail with particular reference to certain preferred embodiments thereof, but it will be understood that variations and modifications can be effected within the scope of the embodiments, especially to those skilled in the art.

### PARTS LIST

8. Multiuse power entry module
12. Power connecting interface
14. Safety ground wire
15. Ring terminal
16. Cordage
18. Thermoplastic material
20. First locking retainer
22. Second locking retainer
24. First flange
25. First bolt
26. Second flange
27. Panel to receive the module
28. First hole
29. Second Bolt
30. Second hole
32. First power node of power connecting interface
34. Second power node of power connecting interface
36. Third power node of power connecting interface
42. Secondary power interface
44. First formed retaining device
46. Second formed retaining device
48. Switch
50. Fuse
52. Circuit Breaker
54. Filter
60. Kiosk
62. Touch Screen
64. Input port
66. Delivery section

1. A multiuse locking power entry module with cordage for supplying power from an outside source to equipment with which the module is in association, wherein the module comprises:
a. a power connecting interface;
b. a safety ground wire;
c. cordage comprising an insulated wire for transferring power from an outside source to the power connecting interface, wherein the power connecting interface, the safety ground wire, and a portion of the cordage, are encapsulated in a thermoplastic material forming an encapsulated body; and
d. a first locking retainer formed from the thermoplastic material on a first side of the encapsulated body and a second locking retainer formed from the thermoplastic material on a second side of the outside of the encapsulated interface body.

2. The power entry module of claim 1, wherein the power connecting interface is formed from the thermoplastic material.

3. The power entry module of claim 1, wherein each locking retainer is a spring retention finger.

4. The power entry module of claim 1, wherein each locking retainer is a flange with at least one opening for receiving a retention device.

5. The power entry module of claim 4, wherein the retention device is a plastic retaining device, a bolt, a threaded screw, or combinations thereof.

6. The power entry module of claim 1, wherein each locking retainer is a flange with at least one formed retaining device formed from the thermoplastic material.

7. The power entry module of claim 1, wherein each locking retainer is a flange with at least one retaining device embedded in the thermoplastic material of the flange.

8. The power entry module of claim 1, wherein the thermoplastic material is a flame retardant material with a V-0 flame rating.

9. The power entry module of claim 1, wherein the thermoplastic material is a polyamide.

10. The power entry module of claim 1, wherein the power connecting interface comprises a shape selected from standard electrical interfaces.

11. The power entry module of claim 1, wherein the module is adapted for DC power.

12. The power entry module of claim 1, wherein the cordage is a multiple conductor cable.

13. The power entry module of claim 1, further comprising a switch embedded within the thermoplastic material and connected between the power connecting interface and the cordage.

14. The power entry module of claim 1, further comprising a fuse embedded within the thermoplastic material and connected between the power connecting interface and the cordage.

15. The power entry module of claim 1, further comprising a circuit breaker embedded within the thermoplastic material and connected between the power connecting interface and the cordage.

16. The power entry module of claim 1, further comprising a filter embedded within the thermoplastic material and connected between the power connecting interface and the cordage.
